(19) United States
(12) Patent Application Publication
(10) Pub. No.: US 2013/0191249 A1
(43) Pub. Date: Jul. 25, 2013

(54) PERSONALIZING CUSTOMER RESPONSE

(71) Applicant: Robyn R. Schwartz, Chicago, IL (US)

(72) Inventor: Robyn R. Schwartz, Chicago, IL (US)

(73) Assignee: INTERNATIONAL BUSINESS MACHINES CORPORATION, Armonk, NY (US)

(21) Appl. No.: 13/355,695

(22) Filed: Jan. 23, 2012

(51) Int. Cl. G06Q 30/00

(52) U.S. Cl. 705/26.61

(57) ABSTRACT

A business uses a computer to personalize a response to a user request. The computer receives a request via a portable device. The computer accesses the current state of the user and a prior state. It also assesses the current state of the business. The computer then gathers the opportunity universe of application components from crowdsourcing and business directed sources and selects a set of applications appropriate to the request. The computer then uses this selected set of components to generate a personalized immediate response to the user request.

### BACKGROUND OF THE INVENTION

1. Field of the Invention

The invention relates to generating immediate responses to customer requests in a retail environment. More particularly, the invention relates to generating responses which are optimally personalized to the requesting customer.

2. Description of the Related Art

Recently, retail technology has begun to use crowdsourcing techniques to identify what customers want. Crowdsourcing techniques were developed for many other purposes, such as U.S. Patent Application 2008/0208849 by Cowell for overcoming shortcomings of fingerprint methods in identifying audio or video content. Jaiswal in European Patent Application 2348477A1 describes methods of applying crowdsourcing techniques though mobile communication networks.

### BRIEF SUMMARY OF THE INVENTION

Crowdsourcing has become a viable method of data collection, e.g., sentiment, trend, event, interest assessment and identification, and application development. For application development in retail, business, entertainment, and gaming, it is used as a tool for popularization of applications and interactions. While this process is valuable for gaining new ideas and bottoms-up thinking, it is not personalized to a user at a specific moment of time. Nor is it very insightful of a learned basis that grows out of and across crowdsourced applications.

Customers today demand extreme personalization, which is contextual, objective, and time based. The present invention addresses this demand through an outgrowth of crowdsourcing, which produced an explosion of application opportunity and data, by providing a self-organizing application. This invention can react to an immediate situation. It is dynamically structured on cognition gained from across usage and anticipated usage as defined by existing applications regardless of whether these applications result from crowdsourced or formally structured business applications.

### BRIEF DESCRIPTION OF THE SEVERAL VIEWS OF THE DRAWINGS

FIG. 1 is a functional block diagram of a system for implementing the present invention;

FIG. 2 is a flowchart illustrating the basic operational steps of an embodiment of the present invention; and

FIG. 3 is a block diagram and hardware and software within and external to the computer of FIG. 1, in accordance with the present invention.

### DETAILED DESCRIPTION OF THE INVENTION

For a better understanding of the present invention, together with other and further objects, advantages, and capabilities thereof, reference is made to the following disclosure and the appended claims in connection with the above-described drawings.

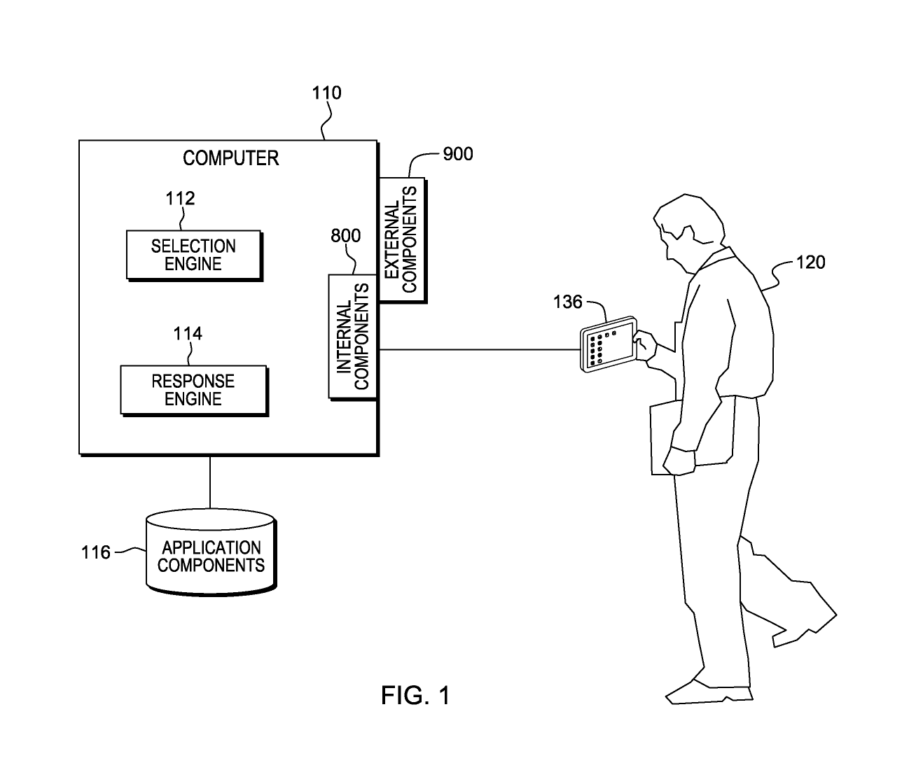

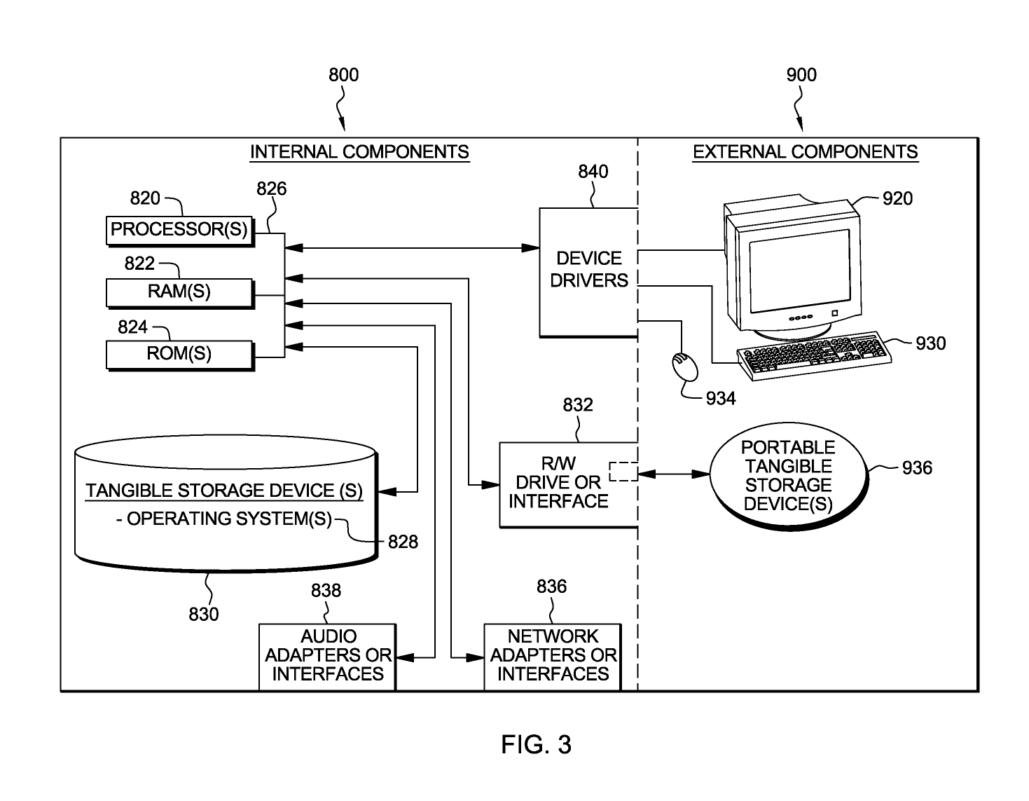

In FIG. 1, there is shown computer 110 having both internal components 800 and external components 900 as described below in connection with FIG. 3. Computer 110 also has various functions stored within for performing individual steps of the present invention. Any type of storage media known in the art may be used to store program instructions for providing the functions. Example storage media include, but are not limited to dynamic random access memory (DRAM), hard drives, flash memory, read only memory (ROM), removable storage, such as CD and DVD disks, floppy disks, or magnetic cores. Selection engine 112 brings together an appropriate set of application components 116 in a manner to be described below. Response engine 114, uses the selected components to generate an immediate response to a request from a user. The operation of response engine 114 is also described in detail below. Application components 116 are also stored on storage media, preferably within computer 110, but may also be stored on external media attached to computer 110, as shown in FIG. 1. Any type of attachment may be used depending on the physical location of the storage media used for application components 116 in relation to computer 110, whether remote or adjacent. Various combinations of remote storage, adjacent storage, and storage within computer 110 may also be used for storing application components 116 without departing from the spirit of the invention as recited in the appended claims.

Computer 110 has an attachment, preferably wirelessly to a device 136 of user 120. Device 136 may be any type of computing device known in the art, such as, but not limited to a computing tablet, laptop, palmtop, smart phone, personal computer, or kiosk.

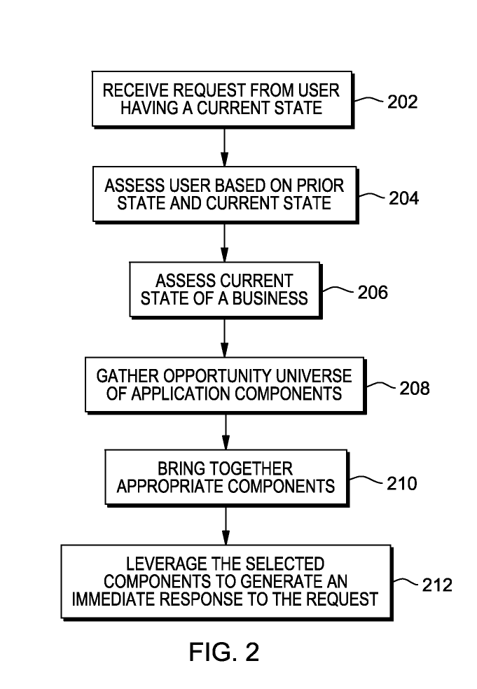

Turning now to FIG. 2, in step 202, computer 110 receives a request from user 120 via device 136. Receipt of this request is the trigger event which starts the process of the present invention. The request may be a product search, a product or service purchase, or an information look-up. The request may also be any type of request a customer may make of a business. User 120 has a current state which shall be take herein to mean a listing of attributes, including but not limited to, the physical location of the user, the type of interfacing device the user is operating whether a portable device or fixed point device, such as a kiosk, and recent clickstream data from the device. Clickstream data shall be taken herein to mean data of any type entered on the device by the user, such as key pad presses, touchscreen taps, mouse or other pointing apparatus entries, or voice entries

In Step 204, computer 110 assesses this user based on this current state and a prior state. Prior state shall be taken herein to mean the listing of attributes of action cluster, relative long-term history, personal preferences, and interaction history. Prior state attributes also include a view of the customer based on collected internal retailer data, including buying habits, micro-demographics and spend.

In step 206, computer 110 assesses the current state of the business that the user is attempting to contact via the request. The current state of the business shall be taken herein to mean business conditions of inventory by channel, retailer or vendor programs, as well as external condition of weather, local events and attributes of the event, including cumulative view of crowdsourcing activity.

In step 208, computer 110 gathers the opportunity universe of application components 116 from their respective locations.

In step 210, computer 110 uses selection engine 112 to bring together a set of the application components, which are appropriate to the request received in step 202, based on the prior state and the current state of the user as assessed in step 204, the current state of the business as assessed in step 206, the request received in step 202, and objectives of the business. The application components include both business derived and crowdsourced components. A user interacting with an electronic system (mobile, pc, kiosk, etc) in support of some action (product search, product/service purchase, information look-up, etc) would trigger an event of self-organization across a universe of application components. Based on a current understanding of this user and the aggregate cognition of related states based on attributes—recognized parameters combine to define an appropriate self-organization state of the components to be able to act in service in favor of the user experience. The self-organizing application results from components aggregated in a moment of time in support of that user's specific needs/demands as matched with the requirements of the business. Business derived and crowdsourced components are brought together to meet the immediate demand as defined dynamically by the user's current state, immediate business conditions, and the user's prior state. The system delivers a temporal experience derived from the components brought together in service of the immediate user request.

In step 212, computer 110 uses response engine 114 to use the application components selected in step 210 to generate an immediate response to the request. Preferably, the selected components include at lease one business derived component which is not based on crowdsourced techniques. Computer 110 understands which components were selected as appropriate for the request received from the user. This is an automated systematic process leveraging self-organization techniques built into response engine 114 that structures the selected components in temporal support of the user's immediate request.

Componentization techniques for business are described in “The Component-Based Business Plug and Play,” by Richard Veryard, Springer, 2001. Rackham, in US Patent Application US 2005/0203784, describes a method of providing business process services to a client company through components of activities. Underwood, in U.S. Pat. No. 6,601,233, describes a framework for business components. Ang, in US Patent Application US 2008/0027784, describes use of componentization in service oriented architecture. The patent application by Ang is hereby incorporated by reference in its entirety for any purpose. Note that the book by Veryard, as well as the patent application by Rackham and the patent by Underwood, are all incorporated by reference in Ang. These three documents are also incorporated herein by reference in their entireties for any purpose.

The self-organizing built into response engine 114 operates on-demand after the request is received. The organization of the components is conditioned on the state of the user and business. As such, the response is personalized to the user, whereas crowdsourcing techniques when used alone are by their nature more generally applied to (typically large) groups of people.

FIG. 3 shows a block diagram of internal components 800 and external components 900 of a computer 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Computer 110 is representative of any electronic device capable of executing machine-readable program instructions. Computer 110 may be representative of a computer system or other electronic devices. Examples of computing systems, environments, and/or configurations that may represented by computer 110 include, but are not limited to, personal computer systems, server computer systems, thin clients, thick clients, laptop devices, smart phones, multiprocessor systems, microprocessor-based systems, network PCs, minicomputer systems, and distributed cloud computing environments that include any of the above systems or devices.

Computer 110 includes a set of internal components 800 and external components 900. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, functions 120, 290, 310, and 410, in computer device 110 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also components includes a R/W drive or interface 832 to read from and write to one or more portable computer-readable tangible storage devices 936 such as a CD-ROM, DVD, memory stick, magnetic tape, magnetic disk, optical disk or semiconductor storage device. Functions 120, 290, 310, and 410, in computer 110 can be stored on one or more of the respective portable computer-readable tangible storage devices 936, read via the respective R/W drive or interface 832 and loaded into the respective hard drive 830.

Internal components 800 also includes audio adapters or interfaces 838 such as a sound card, hardware mixer, amplifier, or other adapters or interfaces for receiving audio signals from microphones.

Internal components 800 also includes network adapters or interfaces 836 such as a TCP/IP adapter cards, wireless wi-fi interface cards, or 3G or 4G wireless interface cards or other wired or wireless communication links. Functions 120, 290, 310, and 410, in computer 110 can be downloaded to computer 110 from an external computer via a network (for example, the Internet, a local area network or other, wide area network) and respective network adapters or interfaces 836. From the network adapters or interfaces 836. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A method for a business having objectives and a current state to respond to a request from a user, comprising the steps of:
A computer system receiving a request via a device from a user having a current state;
The system assessing said user based on a prior state and said current state;
The system assessing said current state of said business;
The system gathering the opportunity universe of application components from a plurality of sources;
the system automatically bringing together an appropriate set of said application components based on said prior state and current state of said user, said current state of said business, said request, and said objectives; and
The system leveraging said set of said application components to immediately act in service of the user by generating an immediate response to said request.

2. The method of claim 1, wherein said request is a product search, a product or service purchase, or an information look-up.

3. The method of claim 1, wherein the system further assesses said user based on said device.

4. The method of claim 1, wherein said prior state comprises an action cluster, relative long-term history, personal preferences, or interaction history.

5. The method of claim 1, wherein said current state of said user comprises a click stream from said device.

6. The method of claim 1, wherein said current state of said business comprises available inventory by channel.

7. The method of claim 1, wherein said current state of said business comprises supplier programs.

8. The method of claim 1, wherein said application components includes both business-derived and crowdsourced components.

9. The method of claim 1, wherein said bringing together comprises an automatic self-organizing process.

10. A system for a business having objectives and a current state, for responding to a request from a user, said system comprising:
A computer in communication with a user device, said user having a current state and a request;
An opportunity universe of application components stored in a database accessible by said computer;
selection engine software running on said computer for bringing together an appropriate set of said application components based on said current state of said user, a prior state of said user, a current state of said business, said request, and said objectives; and
Response engine software running on said computer for using said appropriate set of said application components to generate an immediate response to said request.

11. The system of claim 10, wherein said request is a product search, a product or service purchase, or an information look-up.

12. The system of claim 10, wherein said current state comprises a click stream from said device.

13. The system of claim 10, wherein said current state of said business comprises available inventory by channel.

14. The system of claim 10, wherein said current state of said business comprises supplier programs.

15. The system of claim 10, wherein said application components includes both business-derived and crowdsourced components.

16. The system of claim 10, wherein said bringing together comprises an automatic self-organizing process.

17. A computer program product for instructing a processor to permit a business having objectives and a current state to respond to a request from a user, said computer program product comprising:
A computer readable storage medium:
First program instruction means for receiving a request via a device from a user having a current state;
Second program instruction means for assessing said user based on a prior state and said current state;
Third program instruction means for assessing said current state of said business;
Fourth program instruction means for gathering the opportunity universe of application components from a plurality of sources;
fifth program instruction means for automatically bringing together an appropriate set of said application components based on said prior state and current state of said user, said current state of said business, said request, and said objectives; and
Sixth program instruction means for leveraging said set of said applications to immediately act in service of the user by generating an immediate response to said request; and wherein
All said program instruction means are recorded on said medium.

18. The computer program product of claim 17, wherein said prior state comprises an action cluster, relative long-term history, personal preferences, or interaction history.

19. The computer program product of claim 17, wherein said application components includes both business-derived and crowdsourced components.

20. The computer program product of claim 17, wherein said bringing together comprises an automatic self-organizing process.
